(19) United States
(12) Patent Application Publication
(10) Pub. No.: US 2009/0059602 A1
(43) Pub. Date: Mar. 5, 2009

(54) Directional evacuation lights

(75) Inventors: Fred Santos, Easton, PA (US); Karen D. Lontka, Randolph, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Building Technologies, Inc., Florham Park, NJ (US)

(21) Appl. No.: 12/229,918

(22) Filed: Aug. 28, 2008

Related U.S. Application Data
(60) Provisional application No. 60/967,181, filed on Aug. 31, 2007.

(51) Int. Cl. F21V 1/00; F21V 15/00; G08B 5/00

(52) U.S. Cl. 362/351; 362/362; 340/691.6

(57) ABSTRACT

A directional evacuation lighting apparatus used during an emergency evacuation situation for a building where an emergency sign with direction is projected on the floor to help direct and locate closest safety exit.

### CROSS REFERENCE OF RELATED APPLICATIONS

This patent claims the priority benefit under 35 U.S.C. § 19(e) of U.S. provisional patent application Ser. No. 60/967,181 (2007P18622US), submitted on Aug. 31, 2007; the content of which is hereby incorporated by reference for all purposes.

### FIELD OF INVENTION

The present invention relates to an emergency evacuation system. In particular, this invention relates to directional evacuation lights to aid in an emergency evacuation situation.

### BACKGROUND

Conventional building fire alarm systems include a number of fire detectors positioned throughout a building. Signals from those detectors are monitored by a system controller which, upon sensing an alarm condition, sounds audible alarms throughout the building. Flashing light strobes may also be positioned throughout the building to provide a visual alarm indication, with a number of audible alarms and strobes typically being connected between common power lines in a network.

Exit signs may be seen over every path to an exit in commercial and large residential buildings that are in compliance with applicable fire codes. Modern fixtures are usually in a rugged plastic or metal housing securely bolted to the wall or ceiling. The signs have the word EXIT, or a picture representing exit, on both sides. Single-sided signs are also available for wall-mount installations. The signs often have metal or plastic knock-outs which can be removed so that an arrow is also lit pointing left or right.

When an emergency situation or fire occurs in a building, occupants situated in that building must be evacuated immediately. An alarm signal generating system, an emergency lighting system, a system for displaying and indicating emergency exits and the like are installed to aid in evacuating those occupying the building during the emergency situation or fire.

In the event of a fire, the smoke resulting from the fire may rise and fill the upper portion of a room or a corridor. Additionally, this smoke prevents transmission of the light rays from an emergency lighting system. An occupant who is crawling on the floor or not standing in an upright position, may not be able to read the emergency exit signs or any other evacuation signs located on the walls or on top of an emergency exit door to locate a safe exit from the building.

Therefore there is a need for improvement in evacuation and fire safety systems and in particular directional evacuation lights.

### SUMMARY

It is an object of the invention to provide, a directional evacuation lighting apparatus comprising, a housing for enclosing a projector assembly; a controller in communication with a building alarm system to activate the projector assembly once the building alarm system is triggered; and a power supply.

It is a further object of the invention to provide, a directional lighting evacuation method comprising the steps of, automatically activating a directional evacuation lighting apparatus; and emitting a projection of an emergency signal indicating direction evacuees must escape during emergency from a projector assembly housed inside the directional evacuation lighting apparatus.

### BRIEF DESCRIPTION OF FIGURES

FIG. 1 is a schematic perspective view illustrating the directional evacuation lighting system.

FIG. 2 shows alternative color schemes of the emergency projection with directional element.

FIG. 3 is a perspective view of the directional evacuation light.

FIG. 4 shows the projection assembly for the directional evacuation light.

FIG. 5 shows another embodiment of the projection assembly for the directional evacuation light.

FIG. 6 is a front view of the directional evacuation light showing the projection assembly rotating left and right.

FIG. 7 shows the projection assembly rotating.

FIG. 8 is another schematic perspective view illustrating the directional evacuation lighting system with final exit location projection.

### DETAILED DESCRIPTION

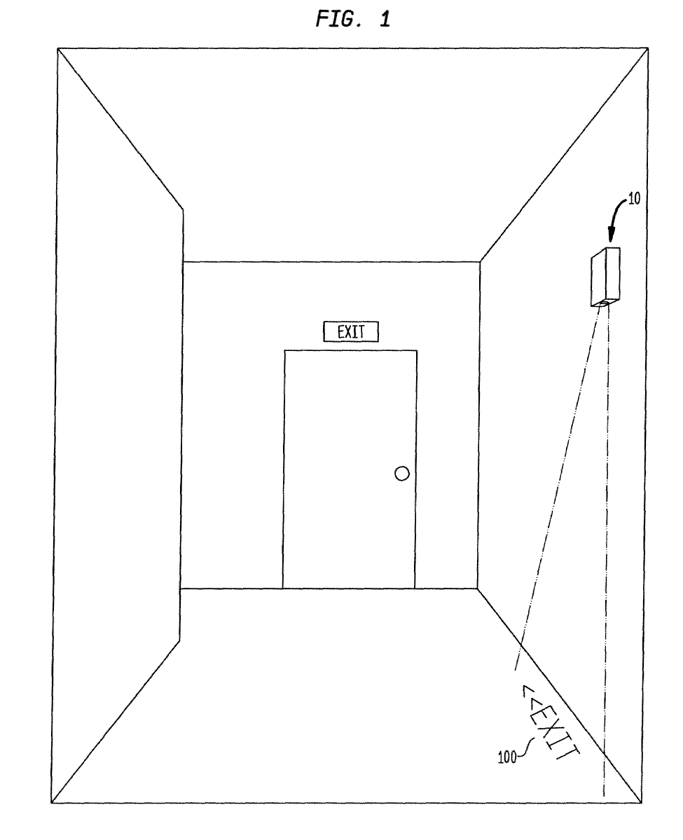

In FIG. 1, the perspective view shows a directional evacuation light 10 for projecting a high intensity light emitting diode (LED) or laser. The directional evacuation light 10 mounts either on a wall or ceiling. The directional evacuation light 10 emits a projection that shows an emergency directional signal 100 pointing to the nearest exit location. The emergency directional signal 100 is the projected text that may include the word EXIT in addition to at least one arrow showing direction of nearest exit location.

The directional evacuation light 10 is initiated by the building controls in which it is situated. For example, if the building's fire alarm system or mass notification system is activated, then the directional evacuation light 10 will be energized. Once the building controller determines an emergency situation has occurred, where an emergency condition may include but not limited to, fire, earthquake, flood, tornado, hurricane, tsunami, or blackout, the building controller will activate the emergency directional signal 100 by activating the directional evacuation light micro controller (not shown) and send relevant information to the directional evacuation light micro controller regarding the emergency event so that the proper signal may be displayed. The transmitted information may be sent via an intelligence communication bus or a signaling circuit as used in the art.

A power supply (not shown) is incorporated within the directional evacuation light 10 in case a building's supply of electric power is cut off. Therefore, the directional evacuation light 10 will stay energized even if the building does not have electric power.

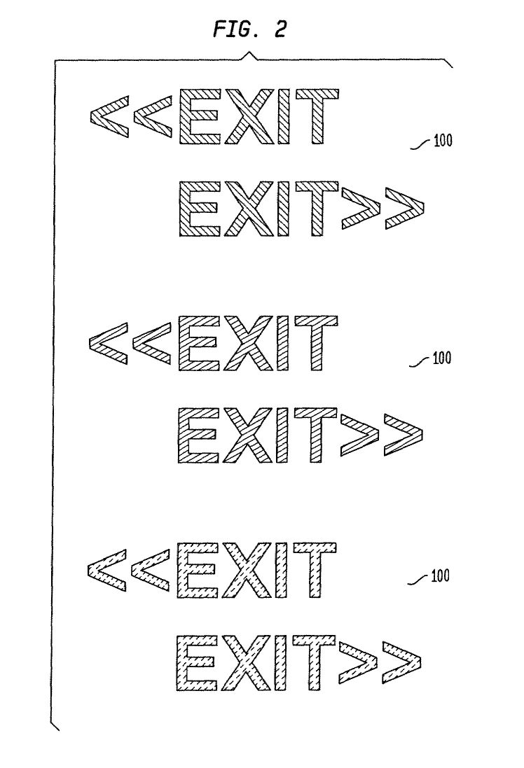

FIG. 2 shows the emergency directional signal 100 as the projected text in an array of color arrangement ranging from red to green based on type of emergency. The color red will be used for fire emergencies; amber will be used for mass notification emergencies which include tornado, chemical spill and the like; green will be used to indicate no emergency at this time.

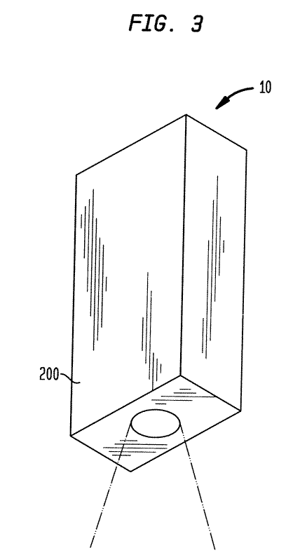

In FIG. 3, the directional lighting evacuation light 10 comprises a housing 200. The housing 200 comprises a metal or high temperature plastic material that is commonly used in the art. The housing 200 may vary on size and shape based on customer's needs and specification.

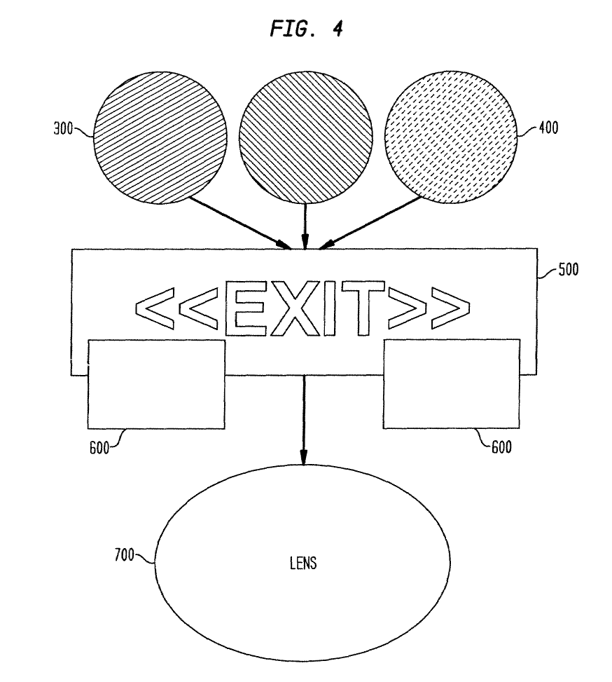

FIG. 4 shows one embodiment of the projection assembly 300 enclosed in housing 200. Projection assembly 300 comprises high intensity light source 400. The high intensity light source 400 comprises light emitting diodes that are laser diodes. The high intensity light source 400 will include the three color schemes mentioned above: red, amber, or green. The projection assembly 300 also comprises a template 500 of the word EXIT with directional arrows. Template 500 may contain any text and any form or graphic of text depending on the need and specification of the customer. Projection assembly 300 also includes a pair of cover plates 600. Cover plates 600 hide the appropriate directional arrow depending on direction that occupants must move based on location of emergency event. For example, if occupants must move to the left for nearest and safest exit away from the emergency event, then cover plate 600 will hide directional arrows pointing in the right direction. Both cover plates 600 may be used to cover both directional arrows when projection text indicates location of exit door. Projection assembly 300 also includes a lens 700 to project the text of template 500 downwards to the floor. Lens 700 is one that is commonly used in projection devices by those skilled in the art.

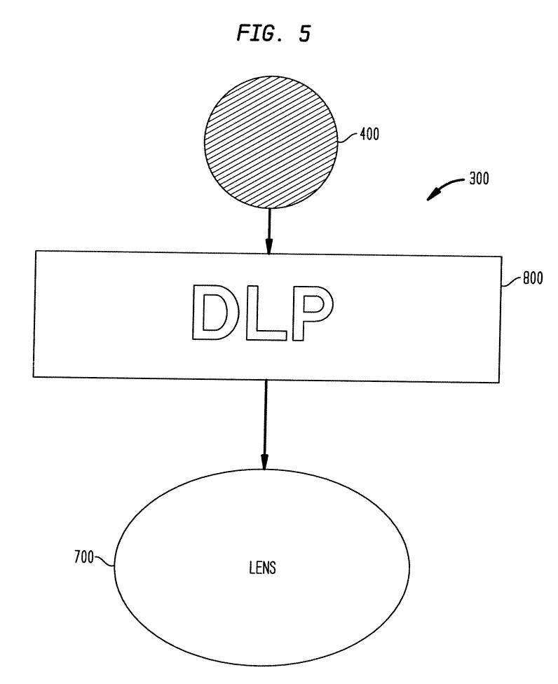

FIG. 5 shows an alternative embodiment for projection assembly 300. In FIG. 5, a digital light processor 800 may be programmed to project appropriate text in appropriate color based on emergency event.

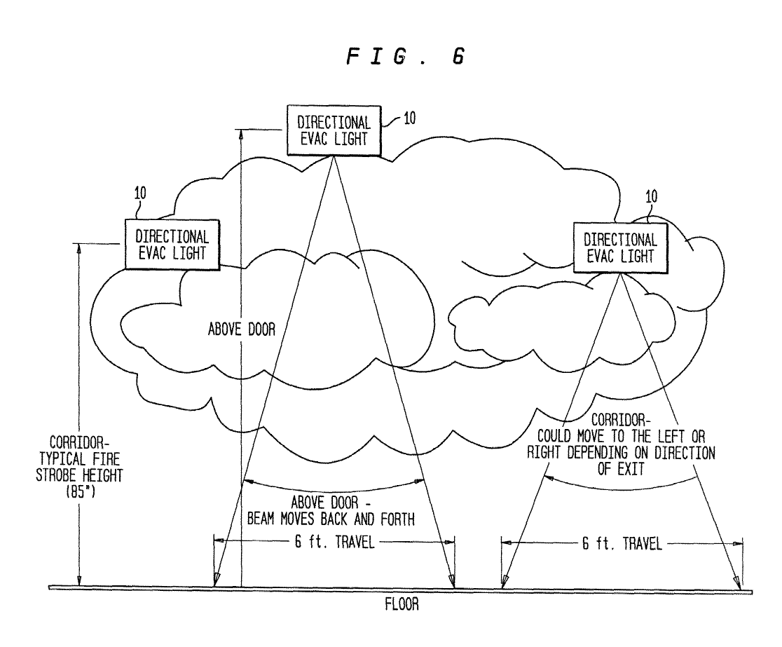

In FIG. 6, the directional evacuation light 10 is preferred to be mounted at 85 inches above ground level. If the directional evacuation light 10 is mounted above an exit door, then the directional evacuation light 10 will be mounted above the exit sign or the door frame. FIG. 6 also shows that projection assembly 300 (not shown here) rotates the emergency directional signal 100 (not shown here) a span on 6 feet on the ground. If the directional evacuation light 10 is above the exit door, then the emergency directional signal 100 showing the word exit will rotate back and forth indicating the location of the exit door. If the emergency directional evacuation light 10 is in a corridor, then the emergency directional signal 100 showing the word exit with direction will rotate left or right depending on direction of exit.

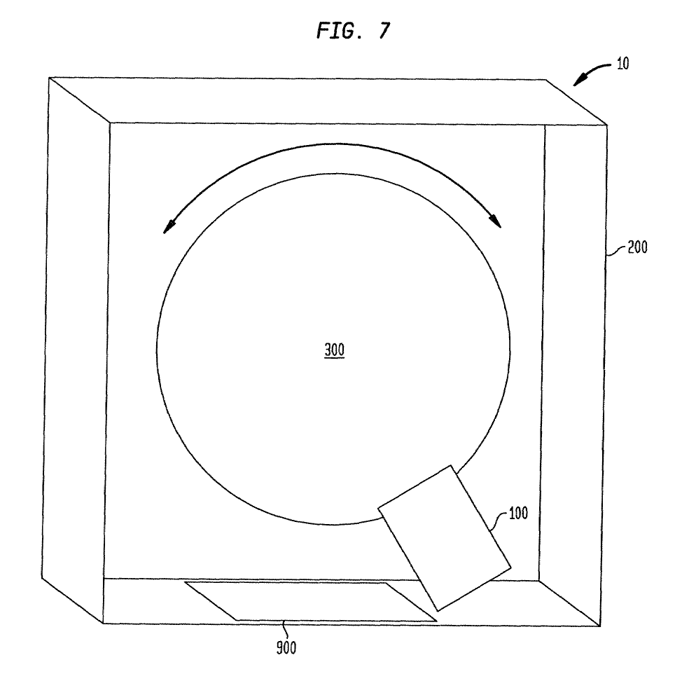

FIG. 7 shows the projection assembly 300 rotating back and forth. Emergency directional signal 100 projects through opening 900. Another alternative embodiment may only rotate the lens 700 in the projection assembly 300.

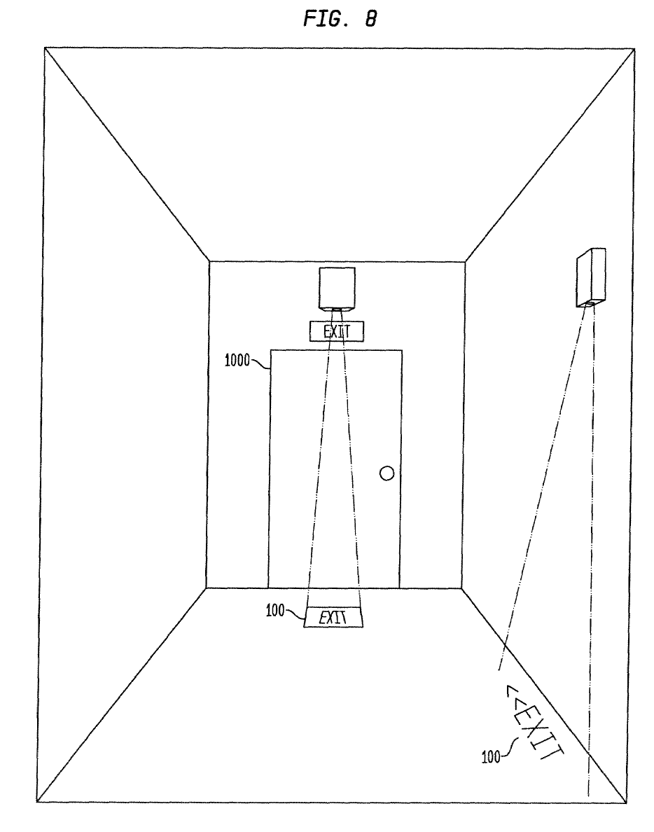

In FIG. 8, the emergency directional light 100 is projected in front of the exit door 1000 to assist occupants to determine final point location of safety exit.

While the foregoing description and drawings represent the preferred embodiments of the present invention, it will be apparent to those skilled in the art that various changes and modifications may be made therein without departing from the true spirit and scope of the present invention.

1. A directional evacuation lighting apparatus comprising,
a housing for enclosing a projector assembly;
a controller in communication with a building alarm system to activate the projector assembly once the building alarm system is triggered; and
a power supply.

2. A directional evacuation lighting apparatus in claim 1, wherein the projector assembly comprises a high intensity light source.

3. The high intensity light source of claim 2, further comprising a laser light emitting diode.

4. A directional evacuation lighting apparatus in claim 1, wherein the projector assembly further comprises a template of an emergency text and at least one directional element.

5. A directional evacuation lighting apparatus in claim 1, wherein the projector assembly further comprises at least one cover plate.

6. A directional evacuation lighting apparatus in claim 1, wherein the projector assembly further comprises a lens.

7. A directional evacuation lighting apparatus in claim 1, wherein the projector assembly comprises a digital light processor.

8. A directional evacuation lighting apparatus in claim 1, wherein the projector assembly rotates indicating which direction occupants should move to safety.

9. A directional evacuation lighting apparatus in claim 1, wherein the projector assembly emits an emergency signal display downward to a floor.

10. A directional lighting evacuation method comprising the steps of,
automatically activating a directional evacuation lighting apparatus; and
emitting a projection of an emergency signal indicating a direction evacuees must escape during emergency from a projector assembly housed inside the directional evacuation lighting apparatus.

11. A directional evacuation lighting method in claim 10, wherein the projector assembly comprises a high intensity light source.

12. A directional evacuation lighting method in claim 11, further comprising a laser light emitting diode.

13. A directional evacuation lighting method in claim 10, wherein the projector assembly further comprises a template of an emergency text and at least one directional element.

14. A directional evacuation lighting method in claim 10, wherein the projector assembly further comprises at least one cover plate.

15. A directional evacuation lighting method in claim 10, wherein the projector assembly further comprises a lens.

16. A directional evacuation lighting method in claim 10, wherein the projector assembly comprises a digital light processor.

17. A directional evacuation lighting method in claim 10, wherein the projector assembly rotates indicating which direction occupants should move to safety.

18. A directional evacuation lighting method in claim 10, wherein the projector assembly emits an emergency signal display downward to a floor.

19. A directional evacuation lighting method in claim 10, wherein a controller of the directional evacuation lighting apparatus is in communication with a controller of the building emergency system.
